(19) United States
(12) Patent Application Publication
(10) Pub. No.: US 2012/0291360 A1
(43) Pub. Date: Nov. 22, 2012

(54) SYSTEM AND METHOD FOR CONFIGURING A SINGLE SEALING MATERIAL FOR A PLURALITY OF DIFFERENT SIZED TRACK SYSTEMS

(76) Inventor: Roland L. Davis, Orlando, FL (US)

(21) Appl. No.: 13/476,757

(22) Filed: May 21, 2012

Related U.S. Application Data
(60) Provisional application No. 61/488,337, filed on May 20, 2011.

(51) Int. Cl. E06B 7/16; B26D 3/00; B23P 19/00; B26D 7/06

(52) U.S. Cl. 49/478.1; 83/648; 83/438; 83/13; 29/800; 49/475.1

(57) ABSTRACT

An apparatus for configuring a gasket material to function with a plurality differently configured track systems, the system including a housing, an opening in the housing through which a gasket material is placed and is moved through, a receiving area through a side of the housing, a cutting device configured with a blade to extend through the receiving area and into the opening, and a slideable cam to define a reach of the blade within the opening.

### CROSS-REFERENCE TO RELATED APPLICATIONS

This application claims the benefit of U.S. Provisional Application No. 61/488,337 filed May 20, 2011, incorporated herein by reference in its entirety.

### BACKGROUND OF THE INVENTION

Exemplary embodiments of the invention generally relate to a gasket used to seal a door and, more particularly, to a universal gasket that is readily configurable for use with a plurality of different track systems.

Using ribbon-like strips of flexible resilient elastomeric or similar deformable material to seal the closure gaps between refrigerator doors and cabinets, or the like, is well-known. The strips are applied marginally, either directly or with the aid of a track, on one or both of the facing surfaces of the door perimeter or abutting shoulder of the cabinet frame. The gasket profile is filled out with a magnetic strip or elastically compressible sponge or other filler to ensure that the gap between the shoulder and frame is filled.

Some gaskets include a base or tail that has a dart-like projection which is inserted into a slot on the track. Others have a “C-shaped” tail or flange that goes under an edge of a door skin or liner, necessitating the removal of the liner for replacement. The gap between a door and frame is filled by the gasket, sometimes having a magnetic strip attached atop a bellows which expands to fill the gap. Other times, the gap is filled by a compression gasket that has an expanded, compressible contour.

Door gaskets for commercial and home refrigerators come in many different profiles with each model refrigerator typically having its own separate original equipment gasket configuration. To replace a gasket, it has been necessary for a service technician to either maintain a large gasket inventory, or suffer delay until a matching gasket can be obtained.

As disclosed in U.S. Pat. Nos. 5,385,628 (“the '628 patent”) and 5,421,944 (“the '944 patent”), Applicant previously developed a new closure sealing system, especially suited to refrigerator door closures, that utilizes a universal replacement gasket and track system. Old “C-shaped” gaskets that had a tail embedded under a door skin could be cut off. Other old gaskets could be removed. Both would be replaced by a single U-shaped guide channel that could applied with any type of fastener (such as but not limited to being screwed, stapled or glued) to the frame or door, and into which a universal gasket would fit. The gasket was of a resilient elastomeric material and included an upper magnet cavity portion, an intermediate expandable, hollow bellows portion and a base portion. The bellows were attached centrally at the top of the base, and the magnet cavity was attached centrally at the top of the bellows. The base comprised equal, opposite outwardly extending flanges formed to be captured beneath corresponding inwardly-turned upper free edges of the guide channel. The magnet cavity was dimensioned to receive a magnetic strip or compressible sponge insert therein. The bellows could be left empty, or filled with a sponge or other compressible filler. Using Applicant's prior art system, once the track has been installed, the universal gasket would fit as a replacement for all other gaskets. The gasket would be used either with or without the magnetic strip, and with or without one or more sponge fillers, so as to meet all gap requirements.

Even though Applicant's previously disclosed system worked well, when considering both the gasket and tracks, typically the tracks are not the components that fail. Usually the main element that fails is the gasket. Additionally, Applicant's prior disclosure provided by a gasket that would work with a specific track system. There is a plurality of other gaskets which are used with a plurality of other track systems. Thus, one gasket may not work with a specific track system. For example, a gasket with a dart would not work with a track system that required a gasket with flanges. Likewise, a gasket with only flanges would not work with a track system that had a track only configured to accept a dart. Furthermore, certain track systems require the dart to be positioned at a certain location along a bottom of the gasket. Hence, service technicians and owners of units would benefit, economically and conveniently, from having a universal gasket that can be used with a multitude of tracks where the gasket and associated magnet, if needed, may be configured to accommodate any one of a plurality of different tracks for immediate use.

### BRIEF DESCRIPTION OF THE INVENTION

Embodiments of the present invention relate to a system and a method for configuring a single gasket, and if used a magnet, to accommodate a plurality of different tracks. An apparatus for configuring a gasket material to function with a plurality differently configured track systems is disclosed. The apparatus comprises a housing, an opening in the housing through which a gasket material is placed and is moved through, a receiving area through a side of the housing, a cutting device configured with a blade to extend through the receiving area and into the opening, and a slideable cam to define a reach of the blade within the opening.

An apparatus for configuring a magnet for use with a plurality of different gasket materials is also disclosed. The apparatus comprises a housing, a cutting element extending from a top of the housing, and an adjustment guide through which a magnet is passed, adjusting the guide defines a width of the magnet once configured.

A method for configuring a gasket to function with a plurality of different track systems is provided. The method comprises providing a gasket configured with at least an upper cavity and at least a base comprising flanges for connecting with a first track system and at least a first attachment and second attachment with each attachment extending from a bottom of the base for at least one attachment connecting with a second track system. If the first track system is available, the method provides for removing the at least first attachment and second attachment with a gasket configuration device that is adjustable to position a blade within an opening in the gasket configuration device to remove the at least first attachment and second attachment with a single pass of the gasket through the gasket configuration device wherein a uniform removal of the at least first attachment and second attachment is provided so that the first attachments and second attachments which are respectively parts of a plurality of gaskets for use with the first track may be uniformly removed with respective single passes through the gasket configuration device. If the second track system is available, also provided is determining a selected attachment between the at least first attachment and second attachment to remove. Adjusting the blade to a position within the opening of the gasket configuration device to cut the selected dart selected for removal and removing the selected dart from the gasket with the gasket configuration device wherein a uniform removal of the selected dart is provided so selected darts which are respectively a part of a plurality of gaskets for use with the second track may be uniformly removed with respective single passes through the gasket configuration device are both also provided.

A universal gasket system is provided comprising an upper cavity portion, a bellows portion attached centrally at a bottom of the upper cavity portion, and a base attached centrally to a bottom of the bellows portion. The base further comprises outwardly extending flanges, a central attachment extending in a generally downward direction from a bottom of the base, and an offset dart extending in a generally downward direction from the bottom of the base. The central attachment and/or the offset attachment are configured to be removed when a track structure requires a single attachment and/or no attachment for securing the system to the track structure.

An apparatus for configuring a gasket material for use with a track structure is disclosed. The apparatus comprises a housing, left and right plates spaced across a gap, means for mounting the plates on the housing for relative movement of the plates with respect to each other, left and right members mounted on the housing for travel with the plates, the members including channels for respectively supporting corresponding left and right lengths of the gasket material with the end edges disposed in spaced, facing positions within the gap, a heater element including heated surfaces, and means for mounting the heater element on the housing for selective movement between a retracted position removed from the gap and an advanced position with the heated surfaces within the gap facing the end edges disposed in the spaced, facing positions. The apparatus also comprises means for biasing the heater element into the retracted position, means for releasably locking the heater element in the advanced position, means for removing one or more attachments extending generally downward from a base of the gasket material located on a surface of the housing, means, cooperative with the plate mounting means, for selectively setting the spacing of the gap to longest, intermediate and shortest spacing positions, and means, cooperative with the selectively setting means and the locking means, for setting the spacing to the longest spacing position and for releasing the heater element from the advanced to the retracted position under action of the biasing means, automatically in response to changing the setting of the plates from the intermediate spacing position, through the longest spacing position, to the shortest spacing position. The selectively setting means comprises a shaft mounted on the housing for selective rotation, a cam mounted on the shaft, and cam followers respectively fixed on the plates and positioned to track the cam.

A method for configuring a gasket material for use with a track structure is disclosed. The method comprises mounting a gasket configuration device on a housing in a position where a cutting element of the device can remove one or more attachments extending generally downward from a base of a gasket material as the gasket material is moved through an opening in the device, a number of attachments to remove being determined by placement of a cam to define a reach of the cutting element within the opening. The method also comprises removing the one or more attachments extending generally downward from the base of the gasket material, mounting left and right plates on the housing for relative movement with respect to one another across a gap, supporting left and right lengths of the gasket material in channels of corresponding left and right members mounted on the housing for travel with the plates, with the end edges disposed in spaced, facing positions within the gap, and providing a heater element movably mounted on the housing, the heater element having heating surfaces. The method also comprises biasing the heater element into an out-of-the-way retracted position out of the gap, using a cam, moving the plates to set the gap to a longest spacing position, with the gap set to the longest spacing position, moving the heater element from the out-of-the-way retracted position to an advanced position with the heating surfaces within the gap facing the end edges, locking the heater element in the advanced position, and using the cam, moving the plates to set the gap to an intermediate position wherein the end edges are in contact with the heating surfaces. The method also comprises using the cam, moving the plates to set the gap to a longest spacing position, using the cam, moving the plates to set the gap to a shortest position wherein the end edges are in contact with each other, and releasing the heater element to move it from the advanced position to the retracted position under action of the biasing means, automatically in response to moving the plates from the intermediate gap space setting position, through the longest gap space setting position, to the shortest gap space setting position.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts an exemplary embodiment of a gasket which can be configured for a plurality of track or channel structures;

FIG. 2 depicts a top view of an exemplary embodiment of a gasket configuration device;

FIG. 3 depicts a front view of an exemplary embodiment of the gasket configuration device;

FIG. 4 depicts a first side view of an exemplary embodiment of the gasket configuration device;

FIG. 5 depicts a second side view of an exemplary embodiment of the gasket configuration device;

FIG. 6 depicts a perspective view of an exemplary embodiment of a magnet configuration device;

FIG. 7 depicts a side view of an exemplary embodiment of the magnet configuration device with a blade compartment exposed; and

FIG. 8 depicts an exemplary embodiment of a flow chart depicting a method for configuring a gasket and magnet.

### DETAILED DESCRIPTION OF THE INVENTION

Reference will be made below in detail to exemplary embodiments of the invention, examples of which are illustrated in the accompanying drawings. Wherever possible, the same reference numerals used throughout the drawings refer to the same or like parts. Exemplary embodiments of the invention solve problems in the art by providing for configuring a gasket, and if used a magnet, to accommodate a plurality of different tracks.

Though gaskets for refrigeration doors are disclosed herein when describing the invention, exemplary embodiments of the invention are applicable to other gasket uses as well. For example, weather stripping of windowsills and doors would also benefit from exemplary embodiments of the invention disclosed herein. Other exemplary uses include, but are not limited to where a cover to an opening separates between two environments. Such covers are of course doors, such as firetrap doors, storm doors, glass doors, blast doors, etc. Thus, the teaching of exemplary embodiments of the invention with respect to gaskets used with refrigeration doors should not be considered limiting.

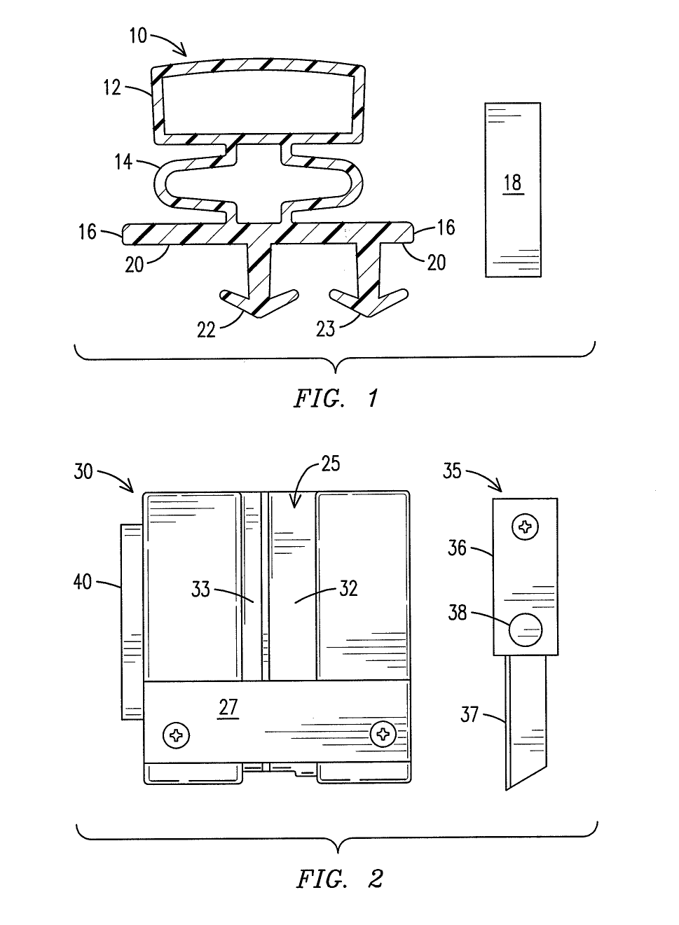

FIG. 1 depicts an exemplary embodiment of a gasket which can be configured for a plurality of a track or channel structure or system. The gasket may be manufactured in a plurality of sizes. As illustrated the gasket (10) comprises an upper cavity portion (12), an intermediate expandable, hollow bellows portion (14) and a base portion (16). A magnet (18) may be placed within the upper cavity portion (12). The bellows (14) are attached centrally at the top of the base (16), and the upper cavity (12) is attached centrally at the top of the bellows (14). The base (16) comprises equal, opposite outwardly extending flanges (20) formed to be captured beneath corresponding inwardly-turned upper free edges of a track or channel. Extending from the base (18) are darts (22, 23). The darts (22, 23) may be considered attachments which are provided to attach the gasket, or gasket material, to a track system. Therefore, the term “dart” should not be considered limiting as to a structure for an attachment used to attach the gasket material to the track system. Thus, the dart may have other configurations than the one illustrated herein. The darts (22, 23) extend in a generally downward direction from a bottom of the base (18). With respect to some track systems, the flanges (20) will fit within an actual track whereas with respect to other track systems, a dart (22, 23) is only able to fit within an actual track. Though two darts (22, 23) are illustrated, more or less darts may be included. Two darts are illustrated where a first dart (22) is located midway between the edges of the base (16) and a second dart (22) that is at an offset location.

Though the gasket (10) is configured with multiple darts (22, 23), an upper cavity (12) and a bellows (14), the gasket (10) may be configured to have other configurations, such as not including the bellows (14) or not including the darts (22, 23). Thus, the configuration of the gasket (10) illustrated is an exemplary embodiment only, whereas a plurality of other gasket designs may be utilized. The gasket design provided, however, is configured so that the gasket (10) can be readily configured to work in connection with any one of a plurality of track systems. The term “readily configured” is used to mean that instead of a technician having to maintain a plurality of differently designed gaskets, or having to order a specifically design gasket, the gasket can be configured upon learning the type of track system the gasket must work with. Thus, as an example, should the technician be one who has a business to service refrigeration units in a geographic area, the technician would only need to have a singularly designed gasket which, as disclosed in further detail below, could then be configured at the work site (hence “readily configured”).

FIG. 2 depicts a top view of an exemplary embodiment of a gasket configuration device used to configure the gasket in accordance with a particular track system. As illustrated, an opening (25) is provided through which the gasket (10) is pulled. A bridge (27), or cover, is provided over a part of the opening (25). The bridge (27) is used to limit, or minimize, the gasket (10) from rising out of the gasket configuration device (30) such as moving vertically upward within the opening (25). The bridge (27) may cover a part of the opening (25) or all of the opening (25). A first track (32) and a second track (33) are visible within the opening. The number of tracks may vary depending on the number of darts that may be available on the gasket.

Next to the gasket configuration device (30) in FIG. 2 is a cutting device (35). The cutting device (35) comprises a blade (37) that is held secured by a holding device (38), such as a fastener (screw, bolt, or other types of fasteners) within a handle (36). The holding device (38) is configured to accept the blade (37) within an opening where the holding device may be used to secure the blade (37) after being placed within the cutting device (35).

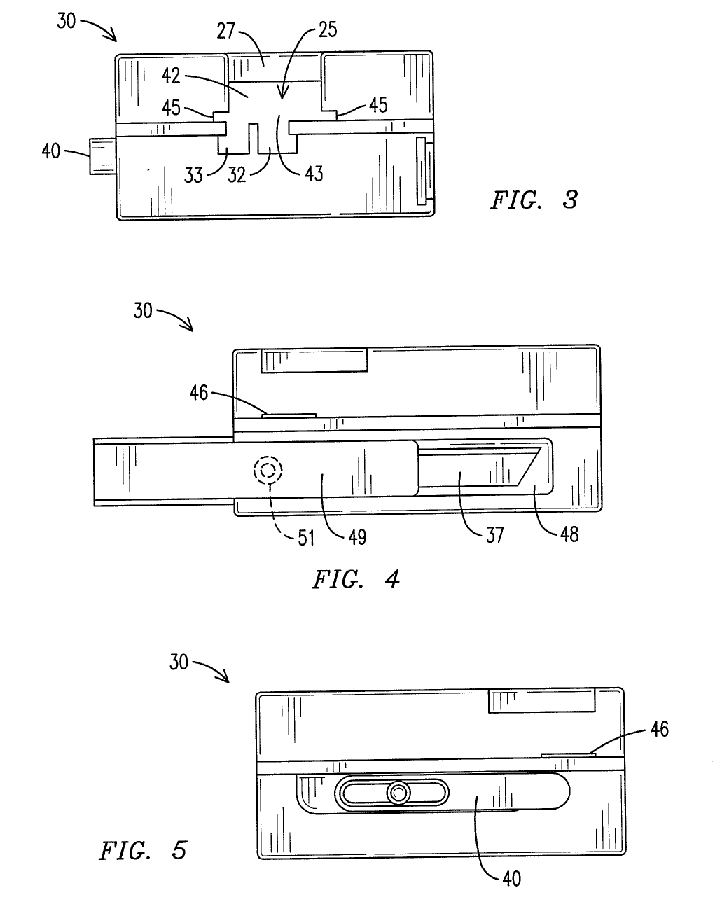

When not used, the cutting device (35) may be configured for storing within the opening (25) of the gasket configuration device (30). For example, the cutting device (35) may be held in place by securing element that wraps around both the gasket configuration device (30) and the cutting device (35) when the cutting device (35) is within the opening (25). In another example, the cutting device (35) is configured to either fit snuggly within the opening (25) or has extrusions that mate with receivers (the receivers are illustrated in FIG. 3).

Also visible in FIG. 2, on one side of the gasket configuration device (30), is a slideable cam (40). As is disclosed in further detail below, the slideable cam (40) may be used as a stopper to limit whether the cutter device (35) removes one or more darts (22, 23) from the gasket (10). Hence, the slidable cam (40) limits a reach of the blade (37) on the cutter device (35).

FIG. 3 depicts a front view of an exemplary embodiment of the gasket configuration device. The opening (25) has a top half (42) and a bottom half (43). The top half (42) and bottom half (43) are separated by side openings (45), or cavities, configured to receive the flanges (16) of the gasket (10). Though two are illustrated, an opening (25) may be configured where only a single cavity (45) is needed. The cavities (45) further assist in holding the gasket (10) when being passed through the opening (25) during the cutting process. As discussed above, a number of tracks (32, 33), two are illustrated, are provided for the darts (22, 23). Based on the exemplary gasket disclosed above, one track (32) is centered on the gasket configuration device (30) to receive the centered dart (22) on the gasket (10) and the other track (33) is off centered, toward the slidable cam (40), to receive the second off centered dart (23).

FIG. 4 depicts a first side view of an exemplary embodiment of the gasket configuration device. A blade slit (46) is viewable. Also disclosed is a storage compartment (48) for the blades (37). The storage compartment (48) has a releasable cover (49) which can cover the blades when not needed. As illustrated, the cover (49) may have a resistance exacting force element (51), such as a ball bearing component which restricts the cover (49) from opening unless force is applied to open the cover (49). Though a single blade slit (46) is illustrated, more than one blade slit may be provided for more than one cutting devices (35) to be used individually or at the same time with other cutting devices. For example, another cutting device (35) may be provided to separate the bellows (12) from the upper cavity (10), which would result in the gasket (10) having the bellows (12) function as a single cavity.

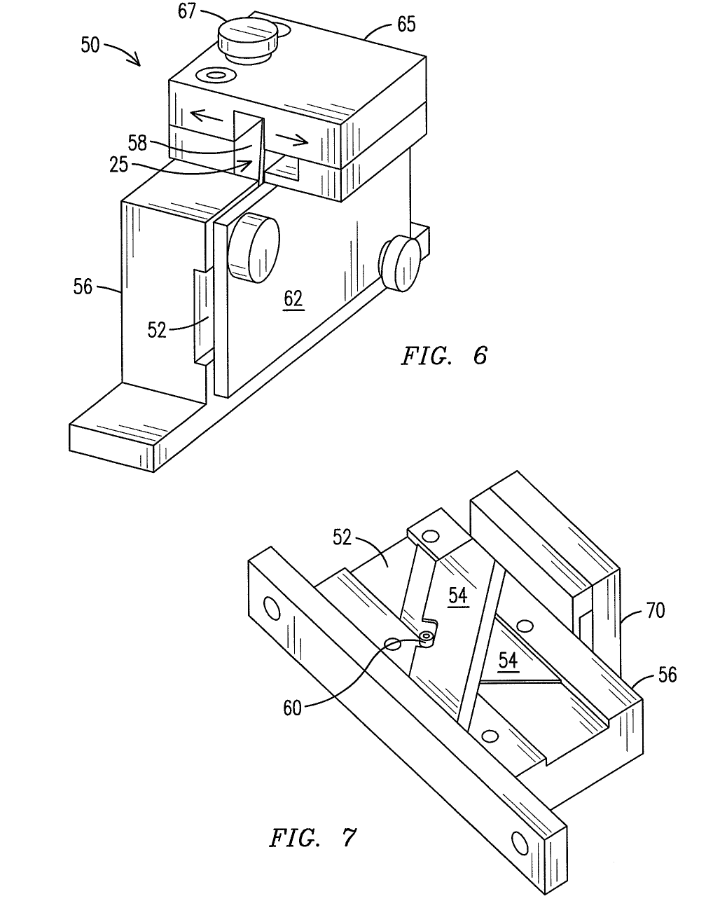

FIG. 5 depicts a second side view of an exemplary embodiment of the gasket configuration device. A second blade slit (46) is viewable. The slidable cam (40) is also further viewable. The gasket configuration device (30) may be used with the cutting device (35) positioned in a top configuration (such as when the holding device (38) is on top) when cutting a dart (22, 23) using the blade slit (46) on the first side view of the gasket configuration device (30). When the cutting device (35) is to be used for cutting the dart (22, 23) from the second blade slit (48) on the opposite side of the gasket configuration device (30), the cutting device (35) is either turned upside down (with a head of the holding device (38) facing downward), or the blade is removed, turned over and then reinserted into the cutting device (35).

When used for cutting, the blade (37) of the cutting device (35) extends through one of the blade slits (46) in the gasket configuration device (30). The cutting device (35) in combination with the gasket configuration device (35) can remove either a single dart or all darts when the gasket (10) is passed through the gasket configuration device (30) one time. When a first, or center, dart (32) is to be removed, the blade (37) of the cutting device (35) extends within the opening (25) after being passed through the blade slit (46). When the blade (37) is passed through the blade slit (48) on a side of the gasket configuration device (30) that does not have the slideable cam (40), the blade (37) only extends far enough within the opening (25) to cut off the first dart (22). When in this configuration, the blade does not extend into the area defined by the second track (33).

If an intended purpose is to, however, remove the second dart (23), the cutting device (35) is located on an opposite side of the gasket configuration device (30) with the blade (37) passing through the second blade slit (46). If the slideable cam (40) is positioned towards the blade slit (46), the cutting device (35) is prohibited from allowing the blade (37) to extend across both tracks, which would allow for both darts to be removed. Instead, with the slideable cam (40) in place, the blade (37) is only in position to remove the second dart (23). When the slideable cam (40) is not moved into a position to restrict the placement of the cutting device (35), the blade (37) extends across both tracks (32, 33), allowing the blade (37) to be in a position to remove both darts (22, 23). Again, though the exemplary embodiment only discloses the gasket configuration device (30) only having two tracks (32, 33) to accommodate two darts (22, 23), additional tracks and additional slideable cams may be included to accommodate other gasket configurations.

In another exemplary embodiment if the current track structure has a void too large to accommodate the gasket, an insertion track may be provided to fit within the current rack structure. The insertion track may provide a void specific to accommodate one or more darts on the gasket or the flanges on the gasket.

FIG. 6 depicts a perspective view of a magnet configuration device. The magnet configuration device (50) has a compartment (52) where blades (54), such as, but not limited to, the type of blades used with box cutters, may be stored.

FIG. 7 depicts a side view of an exemplary embodiment of the magnet configuration device with a blade compartment exposed. The compartment (52) is on a main body (56) of the magnet configuration device (50). Also within the compartment (52), a blade (54) may be positioned to extend outside of the compartment (52) into a cutting area (58). A guide (60) is provided within the compartment (52) to ensure the blade (54) is held in position. The guide (60) may also be used to assist in holding a stored blade (54) in place. Replacing a cover (62) to the compartment (52) further assists to hold the blade (54) in position.

The cutting area (58) is defined by an adjustable magnet insertion element (65). An adjuster (67), such as a fastener, is provided to release and hold the adjustable magnet insertion element (65) stationary once a position is chosen. When released, the adjustable magnet insertion element (65) may be moved to a desired distance (specific lateral movement) left to right along the width of the main body (56) of the magnet configuration device (50). Since exemplary embodiments of the magnet configuration device may not comprise a main body, the adjustable magnet insertion element (65) may be moved to a desired distance left to right along a width of the magnet (18). To ensure uniformity, a scale or other measurement determination element may be placed on the adjustable magnet insertion element (65) for use in combination with the adjuster (67) or main body (56) to establish placement of the adjustment guide (65).

The adjustable magnet insertion element (65) also defines the cutting area (58). Once the position is chosen and the adjuster (61) holding the adjustable magnet insertion element (65) in place is secured and with the blade (54) extending into the cutting area (58), the magnet (18) may be fed through a receiving opening (70). The receiving opening (70) continues through to the cutting area 58. Once the magnet (18) is cut, it will have been configured to be a magnet with a width defined by the position chosen by placement of the magnet insertion element (65). Thus, depending on a size of the gasket (10), specifically the upper cavity (12) into which the magnet (48) will fit, a too large magnet strip can be configured to fit within a plurality of different upper cavities of different gaskets. Having a device (50) with this capability allows for technicians who travel to clients to service different gaskets, or owners of a plurality of devices where more than one size or style of gasket is used, to only store a single uniformed sized magnet when a replacement magnet is needed instead of storing a plurality of different sizes.

Both the gasket configuration device (30) and the magnet configuration device (50) can be mounted (attached or fixed) on a surface to form a singular tool. This singular tool may be a hand held tool or platform. For example, one or both could be attached to a surface on the gasket welding apparatus disclosed in the '944 patent and '628 patent. The '944 patent and the '628 patent are both individually incorporated herein by reference. The attachment may be permanent or where one or both are detachable for later reattachment without damaging one or both devices. In another exemplary embodiment, the gasket configuration device (30) and the magnet configuration device (50) are integrated into the gasket welding apparatus, such as within its housing (on its upper horizontal surface).

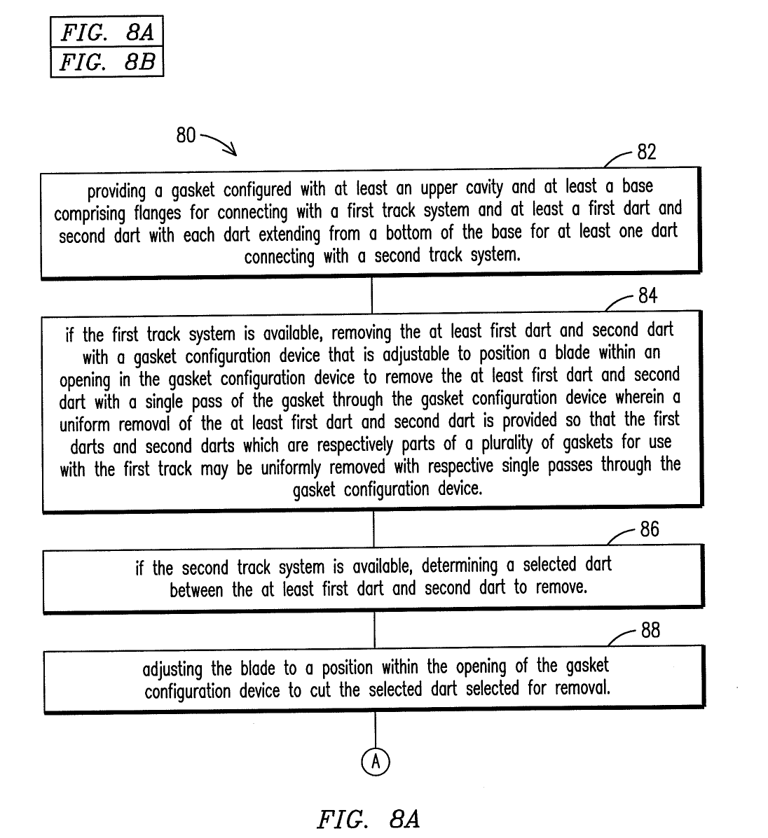

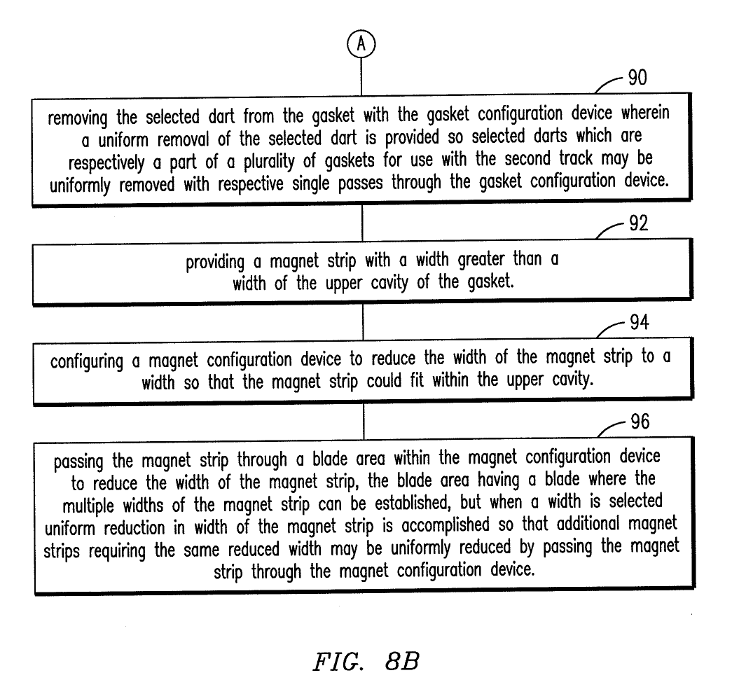

FIG. 8 depicts an exemplary embodiment of a flow chart depicting a method for configuring a gasket and magnet. The flowchart (80) comprises providing a gasket configured with at least an upper cavity and at least a base comprising flanges for connecting with a first track system and at least a first dart and second dart with each dart extending from a bottom of the base for at least one dart connecting with a second track system, at (82). If the first track system is available, the method further comprises removing the at least first dart and second dart with a gasket configuration device that is adjustable to position a blade within an opening in the gasket configuration device to remove the at least first dart and second dart with a single pass of the gasket through the gasket configuration device wherein a uniform removal of the at least first dart and second dart is provided so that the first darts and second darts which are respectively parts of a plurality of gaskets for use with the first track may be uniformly removed with respective single passes through the gasket configuration device, at (84). If the second track system is available, the method may also comprise determining a selected dart between the at least first dart and second dart to remove, at (86), adjusting the blade to a position within the opening of the gasket configuration device to cut the selected dart selected for removal, at (88), and removing the selected dart from the gasket with the gasket configuration device wherein a uniform removal of the selected dart is provided so selected darts which are respectively a part of a plurality of gaskets for use with the second track may be uniformly removed with respective single passes through the gasket configuration device, at (90).

If a magnet is also being used, the method further comprises providing a magnet strip with a width greater than a width of the upper cavity of the gasket, at (92) and configuring a magnet configuration device to reduce the width of the magnet strip to a width so that the magnet strip could fit within the upper cavity, at (94). The method further comprises passing the magnet strip through a blade area within the magnet configuration device to reduce the width of the magnet strip, the blade area having a blade where the multiple widths of the magnet strip can be established, but when a width is selected uniform reduction in width of the magnet strip is accomplished so that additional magnet strips requiring the same reduced width may be uniformly reduced by passing the magnet strip through the magnet configuration device, at (96).

While the invention has been described with reference to various exemplary embodiments, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated, any use of the terms first, second, etc., does not denote any order or importance, but rather the terms first, second, etc., are used to distinguish one element from another.

What is claimed is:

1. An apparatus for configuring a gasket material to function with a plurality differently configured track systems, the system comprising:
a housing;
an opening in the housing through which a gasket material is placed and is moved through;
a receiving area through a side of the housing;
a cutting device configured with a blade to extend through the receiving area and into the opening; and
a slideable cam to define a reach of the blade within the opening.

2. The apparatus according to claim 1, further comprises a number of tracks within a base of the opening, wherein the numbers is equivalent to a number of attachments extended generally downward from a base of the gasket material.

3. The apparatus according to claim 1, further comprises a cover extending over at least a part of the opening to minimize vertical movement of the gasket material.

4. The apparatus according to claim 1, wherein the cutting device further comprises a fastener to release and secure the blade to a handle of the cutting device.

5. The apparatus according to claim 1, wherein the opening further comprises at least one side cavity to receive at least one flange on a base of the gasket material.

6. The apparatus according to claim 1, further comprises a blade storage device within the housing with a releasable cover.

7. An apparatus for configuring a magnet for use with a plurality of different gasket materials, the apparatus comprising:
a housing;
a cutting element extending from a top of the housing; and
an adjustment guide through which a magnet is passed, adjusting the guide defines a width of the magnet once configured.

8. The apparatus according to claim 7, further comprises a measurement device to assist in establishing placement of the adjustment guide.

9. The apparatus according to claim 7, wherein the adjustment guide further comprises a fastener to release and hold secure the adjustment guide to allow a certain width when used to cut the magnet.

10. The apparatus according to claim 7, wherein the adjustment guide is configured to move laterally with respect to a width of the magnet.

11. The apparatus according to claim 7, wherein the adjustment guide comprises an opening to receive the magnet which continues to a cutting area into which the cutting element extends.

12. The apparatus according to claim 7, further comprises a storage compartment within the housing to hold a part of the cutting element and at least one other cutting element.

13. A method for configuring a gasket to function with a plurality of different track systems, the method comprising:
providing a gasket material configured with at least an upper cavity and at least a base comprising flanges for connecting with a first track system and at least a first attachment and second attachment with each attachment extending from a bottom of the base for at least one attachment connecting with a second track system;
if the first track system is available, removing the at least first attachment and second attachment with a gasket configuration device that is adjustable to position a blade within an opening in the gasket configuration device to remove the at least first attachment and second attachment with a single pass of the gasket material through the gasket configuration device wherein a uniform removal of the at least first attachment and second attachment is provided so that the first attachments and second attachments which are respectively parts of a plurality of gaskets for use with the first track may be uniformly removed with respective single passes through the gasket configuration device;
if the second track system is available, determining a selected attachment between the at least first attachment and second attachment to remove;
adjusting the blade to a position within the opening of the gasket configuration device to cut the selected attachment selected for removal; and
removing the selected attachment from the gasket material with the gasket configuration device wherein a uniform removal of the selected attachment is provided so selected attachments which are respectively a part of a plurality of gaskets for use with the second track may be uniformly removed with respective single passes through the gasket configuration device.

14. The method according to 13, further comprising:
providing a magnet strip with a width greater than a width of the upper cavity of the gasket material;
configuring a magnet configuration device to reduce the width of the magnet strip to a width so that the magnet strip could fit within the upper cavity;
passing the magnet strip through a blade area within the magnet configuration device to reduce the width of the magnet strip, the blade area having a blade where the multiple widths of the magnet strip can be established, but when a width is selected uniform reduction in width of the magnet strip is accomplished so that additional magnet strips requiring the same reduced width may be uniformly reduced by passing the magnet strip through the magnet configuration device.

15. The method according to 13, further comprising providing the gasket configuration device as a single hand held device.

16. The method according to claim 14, further comprising providing the magnet configuration device as a single hand held device.

17. The method according to claim 14, further comprising providing the gasket configuration device and the magnet configuration device as part of a singular tool and/or upon a platform.

18. A universal gasket system comprising:
an upper cavity portion;
a bellows portion attached centrally at a bottom of the upper cavity portion;
a base attached centrally to a bottom of the bellows portion, the base further comprising:
outwardly extending flanges;
a central attachment extending in a generally downward direction from a bottom of the base; and
an offset attachment extending in a generally downward direction from the bottom of the base;
wherein the central attachment and/or the offset attachment are configured to be removed when a track structure requires a single attachment and/or no attachment for securing the system to the track structure.

19. The system according to claim 18, further comprises a magnet for placement within at least one of the upper cavity portion and the bellows portion.

20. The system according to claim 18, wherein the at least one attachment is removed so that the gasket system may accommodate a track structure with the outwardly extending flanges.

21. An apparatus for configuring a gasket material for use with a track structure, the apparatus comprising:
a housing;
left and right plates spaced across a gap;
means for mounting the plates on the housing for relative movement of the plates with respect to each other;
left and right members mounted on the housing for travel with the plates, the members including channels for respectively supporting corresponding left and right lengths of the gasket material with the end edges disposed in spaced, facing positions within the gap;
a heater element including heated surfaces;
means for mounting the heater element on the housing for selective movement between a retracted position removed from the gap and an advanced position with the heated surfaces within the gap facing the end edges disposed in the spaced, facing positions;
means for biasing the heater element into the retracted position;
means for releasably locking the heater element in the advanced position;
means for removing one or more attachments extending generally downward from a base of the gasket material located on a surface of the housing;
means, cooperative with the plate mounting means, for selectively setting the spacing of the gap to longest, intermediate and shortest spacing positions; and
means, cooperative with the selectively setting means and the locking means, for setting the spacing to the longest spacing position and for releasing the heater element from the advanced to the retracted position under action of the biasing means, automatically in response to changing the setting of the plates from the intermediate spacing position, through the longest spacing position, to the shortest spacing position;
wherein the selectively setting means comprises a shaft mounted on the housing for selective rotation, a cam mounted on the shaft, and cam followers respectively fixed on the plates and positioned to track the cam.

22. The apparatus according to claim 21, further comprising a means for reducing a width of a magnet for placement of the magnet within a cavity on the gasket material, located on a surface of the housing.

23. A method for configuring a gasket material for use with a track structure, the method comprising:
mounting a gasket configuration device on a housing in a position where a cutting element of the device can remove one or more attachments extending generally downward from a base of a gasket material as the gasket material is moved through an opening in the device, a number of attachments to remove being determined by placement of a cam to define a reach of the cutting element within the opening;
removing the one or more attachments extending generally downward from the base of the gasket material;
mounting left and right plates on the housing for relative movement with respect to one another across a gap;
supporting left and right lengths of the gasket material in channels of corresponding left and right members mounted on the housing for travel with the plates, with the end edges disposed in spaced, facing positions within the gap;
providing a heater element movably mounted on the housing, the heater element having heating surfaces;
biasing the heater element into an out-of-the-way retracted position out of the gap;
using a cam, moving the plates to set the gap to a longest spacing position; with the gap set to the longest spacing position, moving the heater element from the out-of-the-way retracted position to an advanced position with the heating surfaces within the gap facing the end edges;
locking the heater element in the advanced position;
using the cam, moving the plates to set the gap to an intermediate position wherein the end edges are in contact with the heating surfaces;
using the cam, moving the plates to set the gap to a longest spacing position; using the cam, moving the plates to set the gap to a shortest position wherein the end edges are in contact with each other; and
releasing the heater element to move it from the advanced position to the retracted position under action of the biasing means, automatically in response to moving the plates from the intermediate gap space setting position, through the longest gap space setting position, to the shortest gap space setting position.

24. The method according to claim 23, further comprising mounting a magnet configuration device on the housing in a position where a cutting element of the magnet configuration device is located to reduce a width of a magnet by passing the magnet through an opening into which the cutting element extends for later placement of the magnet within a cavity on the gasket material.

25. The method according to claim 23, further comprising reducing the width of the magnet by passing the magnet through the cavity of the magnet configuration device.
